(19) United States
(12) Patent Application Publication
(10) Pub. No.: US 2026/0024878 A1
(43) Pub. Date: Jan. 22, 2026

(54) LITHIUM-SUPPLEMENTING COMPOSITE DIAPHRAGM FOR LITHIUM BATTERIES, LITHIUM BATTERY, AND PREPARATION METHOD THEREOF

(71) Applicant: ADVANCED MATERIALS TECHNOLOGY (BEIJING) CO., LTD., Beijing (CN)

(72) Inventors: Xinsen SUN, Beijing (CN); Weichao FAN, Beijing (CN); Yongwei LI, Beijing (CN); Xiaobing YANG, Beijing (CN)

(73) Assignee: ADVANCED MATERIALS TECHNOLOGY (BEIJING) CO., LTD., Beijing (CN)

(21) Appl. No.: 19/342,596

(22) Filed: Sep. 28, 2025

Related U.S. Application Data
(63) Continuation of application No. PCT/CN2023/139267, filed on Dec. 15, 2023.

(30) Foreign Application Priority Data
Mar. 29, 2023 (CN) 202310323013.1

(51) Int. Cl. H01M 50/457; H01M 10/0525; H01M 10/0585; H01M 10/42; H01M 50/403; H01M 50/431; H01M 50/434; H01M 50/46; H01M 50/463; H01M 50/489

(52) U.S. Cl. CPC H01M 50/457; H01M 10/0525; H01M 10/0585; H01M 10/4235; H01M 50/403; H01M 50/431; H01M 50/434; H01M 50/46; H01M 50/463; H01M 50/489

(57) ABSTRACT

A lithium-supplementing composite diaphragm for lithium batteries, a lithium battery, and a preparation method thereof are provided. The lithium battery includes negative and positive electrode layers. The lithium-supplementing composite diaphragm is arranged therebetween. The lithium-supplementing composite diaphragm comprises: a diaphragm layer, configured to isolate the negative and positive electrode layers; a lithium metal layer, arranged on the side of the diaphragm layer, and configured to supplement lithium to the negative electrode layer; a first protective layer, arranged on the side of the lithium metal layer; and an electronic conductive layer, arranged on the side of the lithium metal layer, and configured to provide an electronic conductive channel between the lithium metal layer and the negative electrode layer. Among them, the orthographic projections of the electronic conductive layer and the first protective layer on the lithium metal layer do not overlap or partially overlap.

### CROSS-REFERENCE TO RELATED APPLICATIONS

The present application is a continuation of International Patent Application No. PCT/CN2023/139267 filed on Dec. 15, 2023, which claims priority to Chinese Patent Application No. 202310323013.1, filed on Mar. 29, 2023. The disclosures of the above-referenced applications are hereby incorporated by reference in their entirety.

### BACKGROUND

Lithium-ion batteries are widely used in daily life as efficient energy storage devices. However, with the rapid development of electronic products, electric vehicles and other technologies, the demand for energy density and cycle life of lithium-ion batteries has continued to increase, making the use of negative electrode materials with high theoretical specific capacity such as Si-based, Si—O-based, and alloys more and more widespread. However, such negative electrode materials undergo large volume change during the charging and discharging process, which makes the electrode interfaces very unstable, resulting in low initial coulombic efficiency and poor cycle performance of the battery.

To solve the above problems, many solutions have been adopted, such as: chemical reduction, artificial SEI, negative electrode pre-lithiation, and so on. Among them, the negative electrode pre-lithiation is the most direct solution.

Methods of negative electrode pre-lithiation are currently mainly divided into four categories: 1. electrochemical pre-lithiation; 2. chemical pre-lithiation; 3. lithium foil method (contact method); 4. stabilized lithium metal powder method. But all four of the above methods have various problems. The electrochemical pre-lithiation is complicated to operate and consumes high energy, resulting in high pre-lithiation costs. The chemical pre-lithiation is very dangerous because the lithium source used is generally flammable and explosive unstable substances. The stabilized lithium metal powder method is also very dangerous, and its raw materials are expensive, also resulting in high pre-lithiation costs. Although the lithium foil method (contact method) is relatively easy to operate, its utilization rate of lithium metal is very low, which makes the pre-lithiation cost high; and because it uses lithium metal, it is also very dangerous. Moreover, the lithium foil method has high requirements on the humidity of the pre-lithiation environment of the electrode sheet and the storage and use environment of the electrode sheet after pre-lithiation, which also makes the pre-lithiation cost higher. In addition, the above four pre-lithiation methods will add new processes and change the existing manufacturing art of lithium batteries, making the production efficiency of lithium batteries lower.

Therefore, there is an urgent need for an efficient and convenient pre-lithiation method that can stably pre-lithiate the negative electrode of lithium batteries without reducing the production efficiency of lithium batteries and has no excessive requirements on the production and storage environment.

### SUMMARY

The present application relates to the field of lithium battery technology, and specifically to a lithium-supplementing composite diaphragm for lithium batteries, a lithium battery, and a preparation method thereof.

The purpose of the present application is to provide a lithium-supplementing composite diaphragm for lithium batteries, a lithium battery and a preparation method thereof, which can solve the technical problem of low initial coulombic efficiency of current lithium batteries.

An embodiment of the present application provides a lithium-supplementing composite diaphragm for lithium batteries, the lithium battery includes a negative electrode layer and a positive electrode layer, the lithium-supplementing composite diaphragm is arranged between the negative electrode layer and the positive electrode layer, and the lithium-supplementing composite diaphragm includes:
a diaphragm layer, configured to isolate the negative electrode layer and the positive electrode layer;
a lithium metal layer, arranged on the side of the diaphragm layer close to the negative electrode layer, and configured to supplement lithium to the negative electrode layer;
a first protective layer, arranged on the side of the lithium metal layer close to the negative electrode layer; and
an electronic conductive layer, arranged on the side of the lithium metal layer close to the negative electrode layer, and configured to provide an electronic conductive channel between the lithium metal layer and the negative electrode layer,
where the orthographic projections of the electronic conductive layer and the first protective layer on the lithium metal layer do not overlap or partially overlap.

In some embodiments, the lithium-supplementing composite diaphragm further includes:
a second protective layer, arranged on the side of the lithium metal layer away from the negative electrode layer.

In some embodiments, the lithium-supplementing composite diaphragm further includes:
a second protective layer, arranged on the side of the diaphragm layer away from the lithium metal layer.

In some embodiments, the shape of the orthographic projection of the electronic conductive layer on the lithium metal layer is island-like, in which the island-like shape includes a plurality of non-continuous islands and/or at least one mesh formed by connecting a plurality of islands.

In some embodiments, the thickness of the electronic conductive layer is greater than the thickness of the first protective layer.

In some embodiments, the thickness of the electronic conductive layer is 10 nm-1,000 nm.

In some embodiments, the coverage rate of the electronic conductive layer on the lithium metal layer is 10%-90%.

In some embodiments, the area of a single electronic conductive layer is 100 nm²-1,000,000 nm².

In some embodiments, the thickness of the first protective layer and/or the second protective layer is 10 nm-1,000 nm.

In some embodiments, the thickness of the lithium metal layer is 0.1 μm-10 μm, and the lithium metal layer is a dense or porous loose structure.

In some embodiments, the material of the electronic conductive layer includes at least one of the following: metal, metal oxide, metal nitride, metal sulfide, or carbon material.

In some embodiments, the metal material includes at least one of the following: gold, silver, copper, iron, titanium, aluminum, manganese, tin, cobalt, nickel, chromium, bismuth, vanadium, molybdenum, or niobium.

The carbon material includes at least one of the following: graphite, hard carbon, soft carbon, graphene, or carbon nanotubes.

In some embodiments, the material of the first protective layer and/or the second protective layer includes at least one of the following:
Al₂O₃, MgO, ZnO₂, TiO₂, ZrO₂, LaO₂, CeO₂, Y₂O₃, SiₓO, SiC, SiNₓ, SiCNₓ, AlN, Mg(OH)₂, BaSO₄, boehmite or perovskite, or
Li₂CO₃, Li₃N, LiF, Li₃PO₄, Li₄SiO₄, Li₄Ti₅O₁₂, LiPON, LiSiON, LLZO, LLZTO, LATP, Li₃Fe₂(PO₄)₃, Li₃V₂(PO₄)₃, Li₃In₂(PO₄)₃, Li₃Sc₂(PO₄)₃, and Li₃Cr₂(PO₄)₃.

In some embodiments, the diaphragm layer is one of the following: a base film, abase film/ceramic composite diaphragm, a base film/adhesive composite diaphragm, and a base film/ceramic/adhesive composite diaphragm.

In some embodiments, the base film includes at least one of the following: a polyethylene base film, a polyethylene nonwoven base film, a polypropylene base film, a polypropylene nonwoven base film, a polypropylene/polyethylene/polypropylene composite base film, a polyimide base film, a polyimide nonwoven base film, a polytetrafluoroethylene base film, a polytetrafluoroethylene nonwoven base film, a polyvinyl chloride base film, or a polyvinyl chloride nonwoven base film; and/or,
the ceramic includes at least one of the following: aluminum oxide, zirconium oxide, boehmite, magnesium hydroxide, barium sulfate, silicon oxide, aluminum nitride, magnesium oxide, titanium dioxide, yttrium oxide, or cerium oxide; and/or,
the adhesive includes at least one of the following: polytetrafluoroethylene, polyvinylidene fluoride, acrylic acid, polyethylene oxide, sodium carboxymethyl cellulose, styrene-butadiene rubber, hydroxypropyl methylcellulose, carboxylated styrene-butadiene latex, or polyvinyl alcohol.

In some embodiments, the lithium layer includes at least one of the following: lithium metal, lithium silicon alloy, lithium magnesium alloy, lithium copper alloy, lithium silver alloy, lithium beryllium alloy, lithium zinc alloy, lithium cadmium alloy, lithium aluminum alloy, lithium gold alloy, and lithium boron alloy.

An embodiment of the present application provides a lithium battery, including the lithium-supplementing composite diaphragm as described in any one of the above items, in which the negative electrode layer includes a negative electrode current collector layer and a negative electrode active material layer covering the negative electrode current collector layer; the positive electrode layer includes a positive electrode current collector layer and a positive electrode active material layer covering the positive electrode current collector layer.

An embodiment of the present application provides a preparation method of a lithium-supplementing composite diaphragm, including the following steps:
providing a diaphragm layer;
forming a lithium metal layer on one side of the diaphragm layer;
forming an electronic conductive layer on the surface of the lithium metal layer; and
forming a first protective layer on the surface of the lithium metal layer, in which the orthographic projections of the electronic conductive layer and the first protective layer on the lithium metal layer do not overlap or partially overlap.

In some embodiments, forming a lithium metal layer on one side of the diaphragm layer includes:
forming a second protective layer on one side of the diaphragm layer; and
forming a lithium metal layer on the surface of the second protective layer.

In some embodiments, forming a lithium metal layer on one side of the diaphragm layer includes:
forming a second protective layer on one side of the diaphragm layer; and
forming a lithium metal layer on the side of the diaphragm layer opposite to the second protective layer.

In some embodiments, the method for forming the first protective layer and/or the second protective layer includes at least one of the following:
blade coating, roller coating, spray coating, chemical vapor deposition, plasma vapor deposition, atomic layer deposition, pulsed laser deposition, vacuum evaporation, ion plating, radio frequency sputtering, magnetron sputtering, or reactive sputtering.

In some embodiments, the method for forming the electronic conductive layer includes at least one of the following: blade coating, roller coating, spray coating, chemical vapor deposition, plasma vapor deposition, atomic layer deposition, pulsed laser deposition, vacuum evaporation, ion plating, radio frequency sputtering, magnetron sputtering, or reactive sputtering.

In some embodiments, the method for forming the lithium metal layer includes at least one of the following:
vacuum evaporation, ion plating, radio frequency sputtering, magnetron sputtering, or reactive sputtering.

An embodiment of the present application provides a preparation method of a lithium battery, including the following steps:
preparing a lithium battery negative electrode, in which the lithium battery negative electrode includes a negative electrode current collector layer and a negative electrode active material layer covering the negative electrode current collector layer;
preparing a lithium battery positive electrode, in which the lithium battery positive electrode includes a positive electrode current collector layer and a positive electrode active material layer covering the positive electrode current collector layer;
preparing a lithium-supplementing composite diaphragm, in which the preparation method of the lithium-supplementing composite diaphragm adopts the method according to any one of the above; and
assembling the lithium-supplementing composite diaphragm between the lithium battery negative electrode and the lithium battery positive electrode, so that the electronic conductive layer is attached to the negative electrode active material layer.

Compared with the existing art, the embodiment of the present application has the following technical effects:

The lithium-supplementing composite diaphragm described in the present application can be directly applied to negative electrode lithium supplementation. The lithium-supplementing composite diaphragm provides electronic conductive paths and ionic conductive paths between the lithium layer and the negative electrode active material. After assembling the battery, a solid electrolyte interface (SEI) can be formed in situ, reducing the loss of active lithium and improving the coulombic efficiency and cycle life of the lithium battery. In addition, the lithium-supplementing composite diaphragm described in the present application has a protective layer on both sides of the lithium layer, which isolates the lithium layer from contact with the external environment, so that the lithium layer does not react with air and/or water in the environment, making the lithium-supplementing composite diaphragm have relatively low requirements for the storage environment.

### BRIEF DESCRIPTION OF DRAWINGS

The drawings herein are incorporated into and form a part of the specification, showing embodiments of the present application, and are used together with the specification to explain the principle of the present application. Obviously, the drawings described below are only some embodiments of the present application, and those skilled in the art can derive other drawings from these drawings without creative efforts. Among the figures:

FIG. 1 is a structural schematic diagram of the lithium-supplementing composite diaphragm of some embodiments of the present application.

FIG. 2 is a structural schematic diagram of the pattern structure of the electronic conductive layer of the lithium-supplementing composite diaphragm of some embodiments of the present application.

FIG. 3 is a structural schematic diagram of the lithium-supplementing composite diaphragm of some other embodiments of the present application.

FIG. 4 is a structural schematic diagram of the lithium-supplementing composite diaphragm of some other embodiments of the present application.

FIG. 5 is a structural schematic diagram of the lithium-supplementing composite diaphragm of some other embodiments of the present application.

FIG. 6 is a structural schematic diagram of the lithium batteries in some embodiments of the present application.

FIG. 7 is a structural schematic diagram of the lithium batteries in some other embodiments of the present application.

FIG. 8 is a flow chart of the preparation method of the lithium-supplementing composite diaphragm in some embodiments of the present application.

FIG. 9 is a flow chart of the preparation method of the lithium batteries in some embodiments of the present application.

FIG. 10 is a schematic diagram of open circuit voltage change curves of some embodiments and Comparative Examples of the present application.

FIG. 11 is a schematic diagram of the first charge and discharge curves of some embodiments and Comparative Examples of the present application.

FIG. 12 is a schematic diagram of the experimental results of the initial state of Embodiment 1 and Embodiment 2 of the present application.

FIG. 13 is a schematic diagram of the experimental results of Embodiment 1 and Embodiment 2 after being placed for 15 days of the present application.

FIG. 14 is a schematic diagram of the experimental results of Embodiment 1 and Embodiment 2 after being placed for 30 days of the present application.

FIG. 15 is a schematic diagram of open circuit voltage change curves after 30 days of storage of some embodiments and Comparative Examples of the present application.

FIG. 16 is a schematic diagram of the room-temperature cycle results of some embodiments and Comparative Examples of the present application.

### DETAILED DESCRIPTION

In order to make the objectives, technical solutions, and advantages of the present application more clear, the present application will be further described in detail below with reference to the drawings. Obviously, the embodiments described are only some, not all, of the embodiments of the present application. All other embodiments, derived by those of ordinary skill in the art based on the embodiments of the present application without inventive efforts, are all intended to be included within the scope of protection of the present application.

The terminology used in the embodiments of the present application is for purposes of describing particular embodiments only and not intended to limit the present application. The singular forms of “a”, “the” and “this” as used in embodiments of the present application and the appended claims are further intended to include the plurality of forms, unless the context clearly indicates other meanings, “multiple” generally includes at least two.

It should be understood that the term “and/or” as used in this document is only an association relationship describing associated objects, indicating that three relationships can exist, e.g., A and/or B, which may indicate that there are three cases: A alone, both A and B, and B alone. In addition, the character “/” in this document generally indicates that the context-related object is an “or” relationship.

It should be understood that although the terms first, second, third and so on may be used to describe in embodiments of the present application, these should not be limited to these terms. These terms are used only to differentiate. For example, the first may also be referred to as a second without departing from the scope of embodiments of the present application, and similarly, the second may also be referred to as a first.

It should also be clarified that the terms “comprise”, “include” or any other variation thereof are intended to cover non-exclusive inclusion, so that a commodity or installation comprising a list of elements includes not only those elements but also other elements not expressly listed therein, or elements inherent in such commodity or installation. Without further limitation, an element qualified by the phrase “comprising a” does not preclude the presence of additional identical elements in the commodity or installation that include such an element.

In the related technology of lithium battery preparation, due to the poor electronic conductivity of the positive and negative electrode diaphragms used in lithium-ion batteries and the poor lithium-ion conductivity, the lithium-ion batteries have disadvantages such as low initial coulombic efficiency (coulombic efficiency refers to the ratio of the battery's discharge capacity to the charge capacity during the same cycle. The input electricity often cannot be fully used to convert the active material to the charged state, but part of it is consumed, such as irreversible side reactions, so the coulombic efficiency is often less than 100%), and poor cycle performance. Pre-lithiation or lithium supplementation of the negative electrode is the most direct method to improve the performance of the negative electrode. Therefore, there is an urgent need for an efficient and convenient lithium supplementation method that can stably supplement lithium to the negative electrode of lithium batteries without reducing the production efficiency of lithium batteries and has no excessive requirements on the production and storage environment.

An embodiment of the present application provides a lithium-supplementing composite diaphragm for lithium batteries. The lithium battery includes a negative electrode layer and a positive electrode layer. The lithium-supplementing composite diaphragm is arranged between the negative electrode layer and the positive electrode layer to isolate the negative electrode layer and the positive electrode layer, and supplement lithium to the negative electrode layer, in which the lithium-supplementing composite diaphragm includes: a diaphragm layer, configured to isolate the negative electrode layer and the positive electrode layer; a lithium metal layer, arranged on the side of the diaphragm layer close to the negative electrode layer, and configured to supplement lithium to the negative electrode layer; a first protective layer, arranged on the side of the lithium metal layer close to the negative electrode layer; and an electronic conductive layer, arranged on the side of the lithium metal layer close to the negative electrode layer, and configured to provide an electronic conductive channel between the lithium metal layer and the negative electrode layer. Among them, the orthographic projections of the electronic conductive layer and the first protective layer on the lithium metal layer do not overlap or partially overlap.

The lithium-supplementing composite diaphragm of the present application can be directly applied to negative electrode lithium supplementation, thereby improving the initial coulombic efficiency and cycle life of lithium battery. The lithium-supplementing composite diaphragm of the present application can control the degree of lithium supplementation (pre-lithiation) by regulating the thickness of the lithium metal layer, and improves the utilization rate of lithium in the pre-lithiation process. The composite diaphragm of the present application reduces the generation of dead lithium and further improves the utilization rate of lithium by providing an electronic conductive channel between the lithium metal layer and the negative electrode active material. The lithium-supplementing composite diaphragm of the present application does not change the normal production process of lithium batteries and will not reduce the production efficiency of lithium batteries. The lithium-supplementing composite diaphragm of the present application has a protective layer on both sides of the lithium metal layer, which isolates the lithium metal layer from contact with the external environment, so that the lithium metal layer does not react with air and/or water in the environment, making the lithium-supplementing composite diaphragm have relatively low requirements for the storage environment. In addition, the lithium-supplementing composite diaphragm of the present application provides electronic conductive paths and ionic conductive paths between the lithium metal layer and the negative electrode active material. After assembling the battery, a solid electrolyte film (SEI) can be formed in situ, further reducing the loss of active lithium and improving the coulombic efficiency and cycle life of the lithium battery.

Optional embodiments of the present application are described in detail below with reference to the drawings.

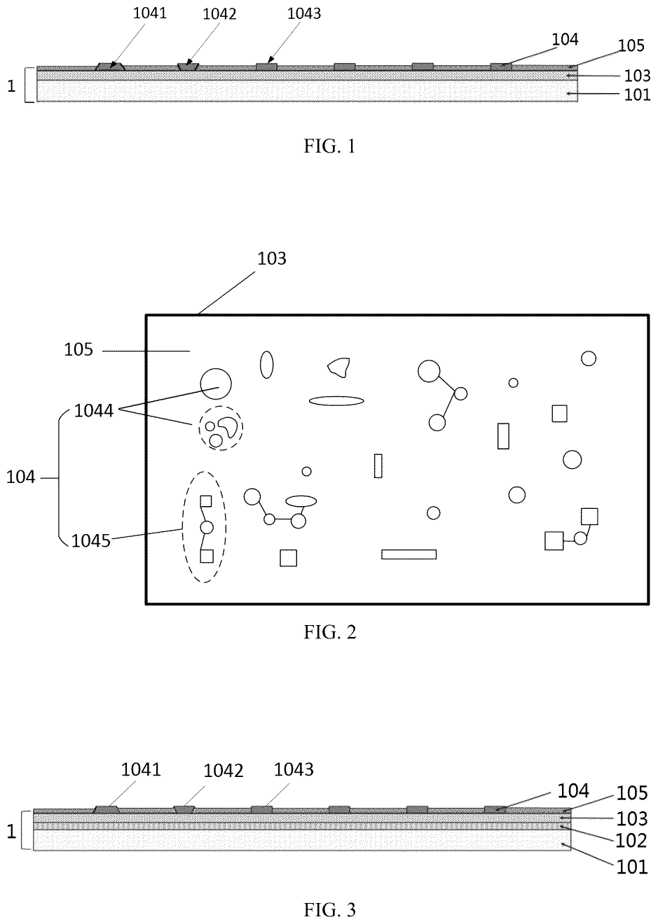

As shown in FIG. 1 and FIG. 6, an embodiment of the present application provides a lithium-supplementing composite diaphragm 1 for lithium batteries. The lithium battery includes a negative electrode layer 3 and a positive electrode layer 4. The lithium-supplementing composite diaphragm 1 is arranged between the negative electrode layer 3 and the positive electrode layer 4. The lithium-supplementing composite diaphragm 1 can directly supplement lithium to the negative electrode layer 3 of the lithium battery, thereby improving the initial coulombic efficiency and cycle life of the lithium battery. As shown in FIG. 6, the negative electrode layer 3 includes a negative electrode current collector layer 301 and a negative electrode active material layer 302. The positive electrode layer 4 includes a positive electrode current collector layer 401 and a positive electrode active material layer 402. Among them, as shown in FIG. 1, the lithium-supplementing composite diaphragm 1 includes: a diaphragm layer 101, configured to isolate the negative electrode layer 3 and the positive electrode layer 4; a lithium metal layer 103, arranged on one side of the diaphragm layer 101 close to the negative electrode layer 3, and configured to supplement lithium to the negative electrode layer 3; a first protective layer 105, arranged on the side of the lithium metal layer 103 close to the negative electrode layer 3; and an electronic conductive layer 104, arranged on the side of the lithium metal layer 103 close to the negative electrode layer 3, and configured to provide an electronic conductive channel between the lithium metal layer 103 and the negative electrode layer 3. Among them, the orthographic projections of the electronic conductive layer 104 and the first protective layer 105 on the lithium metal layer 103 do not overlap or partially overlap.

In some embodiments, as shown in FIG. 1 and FIG. 6, the diaphragm layer 101 is configured to separate the negative electrode layer 3 and the positive electrode layer 4, and its thickness is usually 5 μm-300 μm, for example, 50 μm, 100 μm, 200 μm, 250 μm, etc., and it will not be elaborated here. Different thicknesses can be selected according to the material type of the diaphragm layer 101. If the thickness of the diaphragm layer 101 is greater than 300 μm, the preparation efficiency of the lithium battery will be reduced. If the thickness of the diaphragm layer 101 is less than 5 μm, the positive and negative electrodes of the lithium battery will be easily broken down, leading to a short circuit.

Among them, in some embodiments, the types of the diaphragm layer may include the base film, the base film/ceramic composite diaphragm, the base film/adhesive composite diaphragm, and the base film/ceramic/adhesive composite diaphragm.

Among them, the base film can be at least one or a combination of the polyethylene base film, the polyethylene nonwoven fabric base film, the polypropylene base film, the polypropylene nonwoven fabric base film, the polypropylene/polyethylene/polypropylene composite base film, the polyimide base film, the polyimide nonwoven fabric base film, the polytetrafluoroethylene base film, the polytetrafluoroethylene nonwoven fabric base film, the polyvinyl chloride base film, and the polyvinyl chloride nonwoven fabric base film. The type and number of the combination are not limited.

The ceramic may be at least one or a combination of aluminum oxide, zirconium oxide, boehmite, magnesium hydroxide, barium sulfate, silicon oxide, aluminum nitride, magnesium oxide, titanium dioxide, yttrium oxide, and cerium oxide. The type and number of the combination are not limited.

The adhesive can be at least one or a combination of polytetrafluoroethylene, polyvinylidene fluoride, acrylic acid, polyethylene oxide, sodium carboxymethyl cellulose, styrene-butadiene rubber, hydroxypropyl methylcellulose, carboxylated styrene-butadiene latex, and polyvinyl alcohol. The type and number of the combination are not limited.

In some embodiments, as shown in FIG. 1 and FIG. 6, the lithium metal layer 103 is arranged on the side of the diaphragm layer 101 close to the negative electrode layer 3 as a core layer for lithium supplementation. The thickness of the lithium metal layer is 0.1 μm-10 μm, for example, 0.1 μm-0.3 μm, 0.3 μm-1 μm, 1 μm-3 μm, 3 μm-6 μm, 6 μm-10 μm, etc., and it will not be elaborated here. Different thicknesses can be selected according to the material type of the lithium metal layer. By adjusting the thickness of the lithium metal layer, the degree of lithium supplementation (pre-lithiation) can be controlled, which can improve the utilization rate of lithium in the pre-lithiation process. Among them, the surface of the lithium metal layer can be a dense material or a porous loose structure material, which is not limited.

In some embodiments, the material of the lithium metal layer can be pure lithium metal, a lithium alloy material, or a composite layer of pure metal lithium and the lithium alloy material, in which the lithium alloy material includes, for example, at least one or a combination of the following: lithium metal, lithium silicon alloy, lithium magnesium alloy, lithium copper alloy, lithium silver alloy, lithium beryllium alloy, lithium zinc alloy, lithium cadmium alloy, lithium aluminum alloy, lithium gold alloy, and lithium boron alloy. The free combination of the above materials is not specifically limited.

In some embodiments, as shown in FIG. 1 and FIG. 6, the first protective layer 105 is arranged on the side of the lithium metal layer 103 close to the negative electrode layer 3. The first protective layer 105 is a layer arranged between the lithium metal layer 103 and the negative electrode layer 3. The first protective layer 105 partially covers the lithium metal layer 103, for example, partially covers 10%-90% of the lithium metal layer 103 to prevent the lithium metal layer 103 from being partially or fully exposed to the air, water-containing air, and/or water. Since the lithium metal layer is easy to react with air or water, the first protective layer 105 isolates the lithium metal layer from the external environment, prevents the lithium metal layer from contact with air and/or moisture, reduces the occurrence of side reactions of the lithium metal layer, protects the lithium metal layer, and thus reduces its demand for the storage environment.

In some embodiments, the thickness of the first protective layer is 10 nm-1,000 nm, for example, 10 nm-100 nm, 100 nm-300 nm, 300 nm-600 nm, 600 nm-900 nm, 1,000 nm, etc., and it will not be elaborated here. Different thicknesses can be selected according to the material type of the first protective layer.

In some embodiments, the first protective layer is made of a highly ionic conductive material to provide protection for the lithium metal layer while improving the overall ionic conductivity of the lithium-supplementing composite diaphragm, thereby improving its lithium supplementation efficiency and effect during use. Specifically, the material of the first protective layer can be at least one or a combination of the following, and there is no limitation on the type and number of the combination:
Al₂O₃, MgO, ZnO₂, TiO₂, ZrO₂, LaO₂, CeO₂, Y₂O₃, SiₓO, SiC, SiNₓ, SiCNₓ, AlN, Mg(OH)₂, BaSO₄, boehmite or perovskite, or
Li₂CO₃, Li₃N, LiF, Li₃PO₄, Li₄SiO₄, Li₄Ti₅O₁₂, lithium phosphorus oxide nitrogen (LiPON), LiSiON, lithium lanthanum zirconium oxide (LLZO), tantalum-doped lithium lanthanum zirconium oxide (LLZTO), lithium aluminum titanium phosphate (LATP), Li₃Fe₂(PO₄)₃, Li₃V₂(PO₄)₃, Li₃In₂(PO₄)₃, Li₃Sc₂(PO₄)₃, and Li₃Cr₂(PO₄)₃.

In some embodiments, as shown in FIG. 1 and FIG. 6, the electronic conductive layer 104 is arranged on one side of the lithium metal layer 103 close to the negative electrode layer 3, and is configured to provide an electronic conductive channel between the lithium metal layer 103 and the negative electrode layer 3. The electronic conductive layer 104 and the first protective layer 105 are both arranged on the surface of the lithium metal layer 103, and the orthographic projections of the electronic conductive layer 104 and the first protective layer 105 on the lithium metal layer 103 do not overlap or partially overlap. For example, the electronic conductive layer in FIG. 1 is in a column shape 1043, and its orthographic projection on the lithium metal layer 103 does not overlap with that of the first protective layer 105. For example, the electronic conductive layer in FIG. 1 is in an inverted cone or an inverted frustum shape 1042 or the electronic conductive layer is in an upright cone or an upright frustum shape 1041. The cone or frustum shape can be a regular cone or frustum shape, such as a cone or circular frustum shape, or an irregular cone or frustum shape, and its orthographic projection on the lithium metal layer 103 partially overlaps with that of the first protective layer 105, overlapping at the edge with a small overlapping range, which does not affect the electronic conductive layer to provide an electronic conductive channel. The partial overlap of the orthographic projections of the electronic conductive layer 104 and the first protective layer 105 on the lithium metal layer 103 can increase the sealing performance between the electronic conductive layer 104 and the first protective layer 105, so that there is no gap between the electronic conductive layer 104 and the first protective layer 105, thereby ensuring that the electronic conductive layer 104 and the first protective layer 105 can 100% completely cover the lithium metal layer 103, further completely isolating the lithium metal layer from the external environment, preventing the lithium metal layer from contacting air and/or moisture, reducing the possibility of side reactions of the lithium metal layer, and providing absolute protection for the lithium metal layer.

To illustrate the advantages of the cone-shaped or frustum-shaped electronic conductive layer, for example, one method of forming the electronic conductive layer 104 and the first protective layer 105 is to arrange a mask of the electronic conductive layer, first form the first protective layer by one or a combination of two or more methods such as blade coating, roller coating, spray coating, chemical vapor deposition, plasma vapor deposition, atomic layer deposition, and pulsed laser deposition, then remove the mask, and the form the electronic conductive layer 104 by one or a combination of two or more sputtering methods such as radio frequency sputtering, magnetron sputtering, or reactive sputtering. At this time, each conductive unit in the electronic conductive layer is formed into a cone or frustum shape, which can significantly reduce the gap between each conductive unit and the protective layer, and improve the protection of the lithium metal layer.

As a specific embodiment, the orthographic projections of the electronic conductive layer 104 and the first protective layer 105 on the lithium metal layer 103 do not overlap, and are both in a regular column shape 1043. The electronic conductive layers 104 arranged in a regular matrix can be formed by a mask process to enhance the uniformity of the electronic conductive layers 104.

As a specific embodiment, the orthographic projections of the electronic conductive layer 104 and the first protective layer 105 on the lithium metal layer 103 overlap, and are both in an irregular inverted cone or inverted frustum shape 1042 or an upright cone or upright frustum shape 1041. The electronic conductive layer 104 arranged in a matrix can be formed by a sputtering process to enhance the sealing performance of the electronic conductive layers 104.

In some embodiments, as shown in FIG. 2, the shape of the orthographic projection of the electronic conductive layer 104 on the lithium metal layer 103 is island-like, and the island shape means that the orthographic projection of the electronic conductive layer 104 on the lithium metal layer 103 is an isolated and discontinuous conductive unit, in which the island-like shape includes one or more non-continuous conductive units 1044 and/or at least one mesh 1045 formed by connecting a plurality of conductive units. The electronic conductive layer 104 is arranged on the lithium metal layer 103 in a regular or irregular pattern. For example, the orthographic projection of the electronic conductive layer 104 on the lithium metal layer 103 can be a discontinuous island-like pattern 1044 or a mesh pattern 1045. The discontinuous island-like pattern 1044 can be an aggregate of a plurality of island patterns gathered together but not connected. The mesh pattern 1045 can be a continuous island pattern formed by a plurality of island patterns close to each other. That means multiple conductive units are connected to each other, and there is no limitation on this. The mesh pattern 1045 can be a plurality of island-shaped units linearly connected by conductive material, and the electrical conductivity of multiple island-like units is maintained without changing the position occupied by a single island-like structure. When one of the island-like conductive units is non-conductive, electrons can still be transmitted through other island-like conductive units without changing the conductive area and thus not significantly reducing the conductivity of the electronic conductive layer 104. For the electronic conductive layer 104, the process required to form one or more non-continuous conductive units 1044 and/or at least one mesh 1045 formed by connecting a plurality of conductive units is simple. During the sputtering process, there is no need to specifically control the position of the sputtering point or the amount of sputtered material to form island-shaped conductive units. In the process of forming the first protective layer by evaporation, the growth position of the evaporated material can be flexibly controlled. After forming the cone-shaped conductive units by sputtering, a dense protective layer can be formed around the island-like conductive units by evaporation, which enhances the isolation and protection of the lithium metal layer. In some embodiments, the thickness of the electronic conductive layer 104 is greater than the thickness of the first protective layer 105, so as to preferentially ensure that the lithium metal layer 103 and the negative electrode layer 3 are fully connected through the electronic conductive layer 104, providing an electronic conductive channel for the lithium metal layer 103 to the negative electrode layer 3, so as to improve the lithium supplementation efficiency. The electronic conductive layer provides a high-speed electronic conductive channel between the lithium metal layer and the negative electrode active material, increases the reaction sites between the lithium metal layer and the negative electrode active material, improves the reaction rate of the lithium metal layer, improves the lithium supplementation efficiency, and can also reduce or even avoid the generation of dead lithium, improves the utilization rate of the lithium metal layer, and reduces costs. Without the electronic conductive layer, lithium metal is prone to agglomeration, resulting in the generation of more dead lithium. After adding the electronic conductive layer, the number of reaction sites between the lithium layer and the negative electrode active material increases, the current density is dispersed, and agglomeration is less likely to occur. It can effectively reduce the generation of dead lithium, improve the utilization rate of the lithium layer, and thus save costs.

In some embodiments, the thickness of the electronic conductive layer is 10 nm-1,000 nm, for example, 10 nm-100 nm, 100 nm-300 nm, 300 nm-600 nm, 600 nm-900 nm, 1,000 nm, etc., and it will not be elaborated here. Different thicknesses can be selected according to the material type of the electronic conductive layer.

In some embodiments, as shown in FIG. 1 and FIG. 2, the coverage rate of the electronic conductive layer 104 on the lithium metal layer 103 is 10%-90%, and together with the first protective layer 105, it reaches 100% coverage of the lithium metal layer 103, so that the surface of the lithium metal layer 103 is completely impossible to be exposed to air, water-containing air, and/or water, completely isolating the lithium layer from contact with air and/or moisture, reducing the occurrence of side reactions of the lithium layer, protecting the lithium metal layer and thus reducing its demand for storage environment.

In some embodiments, when the electronic conductive layer is distributed in a plurality of discontinuous islands, the area of a single conductive unit can be 100 nm²-1,000,000 nm², for example, 100 nm²-100,000 nm², 100,000 nm²-500,000 nm², 500,000 nm²-1,000,000 nm², etc., and it will not be elaborated here. Different areas can be selected according to the material type of the electronic conductive layer to ensure the lithium metal layer and the negative electrode layer are fully connected.

In some embodiments, the material of the electronic conductive layer includes at least one or a random combination of the following: metal, metal oxide, metal nitride, metal sulfide or carbon material. Among them, the metal material includes at least one of the following: gold, silver, copper, iron, titanium, aluminum, manganese, tin, cobalt, nickel, chromium, bismuth, vanadium, molybdenum, or niobium. The metal oxide, metal nitride, and metal sulfide are metal oxides, metal nitrides and metal sulfides of gold, silver, copper, iron, titanium, aluminum, manganese, tin, cobalt, nickel, chromium, bismuth, vanadium, molybdenum, or niobium. The carbon material includes at least one of the following: graphite, hard carbon, soft carbon, graphene, or carbon nanotubes.

The lithium-supplementing composite diaphragm of the present application provides electronic conductive paths and ionic conductive paths between the lithium metal layer and the negative electrode active material. After assembling the battery, a solid electrolyte film (SEI) can be formed in situ, further reducing the loss of active lithium and improving the coulombic efficiency and cycle life of the lithium battery.

In some embodiments, as shown in FIG. 3, based on the above-mentioned embodiment, the lithium-supplementing composite diaphragm 1 further includes a second protective layer 102, and the second protective layer 102 is arranged on the side of the lithium metal layer 103 away from the negative electrode layer 3, which can be understood with reference to FIG. 6.

In this embodiment, the second protective layer 102 is attached to the side of the lithium metal layer 103 opposite to the first protective layer 105. By respectively arranging the first protective layer 105 and the second protective layer 102 on the upper and lower surfaces of the lithium metal layer 103, the exposure risk of the other side of the lithium metal layer 103 can be further isolated to avoid partial or full exposure of the lithium metal layer 103 to air, water-containing air, and/or water. Partial exposure can be caused by the penetration of other non-dense film layers (such as air permeability or water permeability) to cause the lithium metal layer 103 to react with air or water. Therefore, by arranging the second protective layer 102, the lithium metal layer can be further completely isolated from the external environment, isolating the lithium metal layer from contact with air and/or moisture, further reducing the occurrence of side reactions of the lithium metal layer, and further protecting the lithium metal layer, thereby reducing its requirements for the storage environment.

In some embodiments, the thickness of the second protective layer is 10 nm-1,000 nm, for example, 10 nm-100 nm, 100 nm-300 nm, 300 nm-600 nm, 600 nm-1,000 nm, etc., and it will not be elaborated here. Different thicknesses can be selected according to the material type of the second protective layer.

In some embodiments, the second protective layer is made of a highly ionic conductive material to provide protection for the lithium metal layer while improving the overall ionic conductivity of the lithium-supplementing composite diaphragm, thereby improving its lithium supplementation efficiency and effect during use. Specifically, the material of the second protective layer can be at least one or a combination of the following, which is not limited:
Al₂O₃, MgO, ZnO₂, TiO₂, ZrO₂, LaO₂, CeO₂, Y₂O₃, SiₓO, SiC, SiNₓ, SiCNₓ, AlN, Mg(OH)₂, BaSO₄, boehmite or perovskite, or,
Li₂CO₃, Li₃N, LiF, Li₃PO₄, Li₄SiO₄, Li₄Ti₅O₁₂, LiPON, LiSiON, LLZO, LLZTO, LATP, Li₃Fe₂(PO₄)₃, Li₃V₂(PO₄)₃, Li₃In₂(PO₄)₃, Li₃Sc₂(PO₄)₃, and Li₃Cr₂(PO₄)₃.

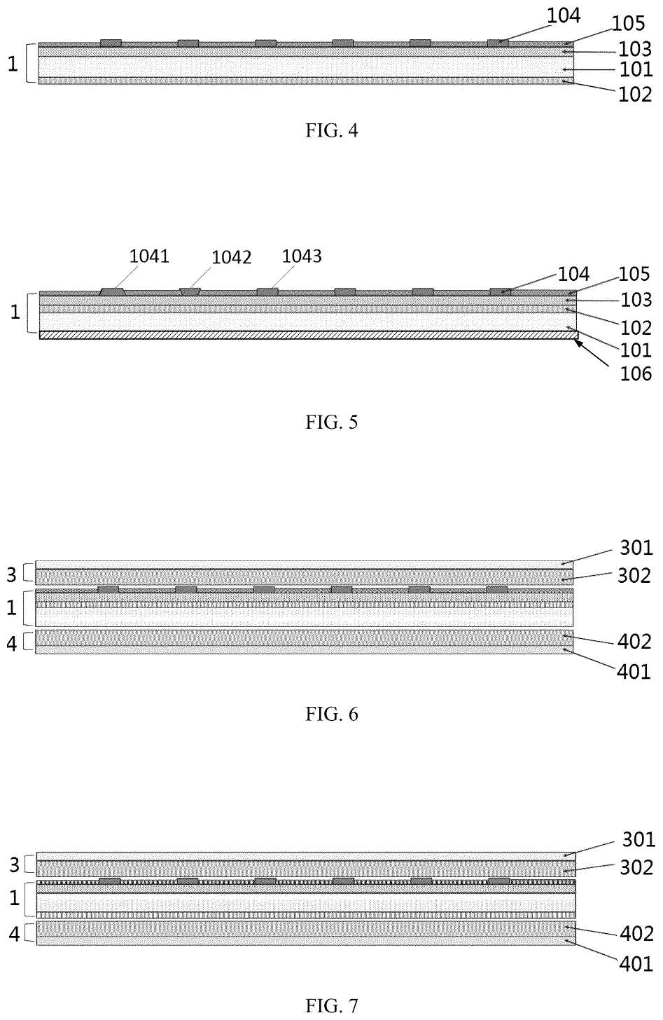

In some other embodiments, as shown in FIG. 4, based on the above-mentioned embodiment, the lithium-supplementing composite diaphragm 1 further includes a second protective layer 102, and the second protective layer 102 is arranged on the side of the diaphragm layer 101 away from the lithium metal layer 103. In this embodiment, the second protective layer 102 is attached to the side of the diaphragm layer 101 opposite to the first protective layer 105. By arranging the second protective layer 102 on the lower surface of the diaphragm layer 101, the upper and lower surfaces of the lithium metal layer 103 are indirectly arranged with the first protective layer 105 and the second protective layer 102 respectively, and the exposure risk of the other side of the lithium metal layer 103 can be further isolated to avoid partial or full exposure of the lithium metal layer 103 to air, water-containing air, and/or water. By arranging the second protective layer 102 on the lower surface of the diaphragm layer 101, the first protective layer 105 and the second protective layer 102 are integrally located on the upper and lower surfaces of the lithium-supplementing composite diaphragm 1, and can protect each film layer inside the lithium-supplementing composite diaphragm 1. Furthermore, the manufacturing art of the second protective layer is simplified, and the overall preparation efficiency of the lithium-supplementing composite diaphragm 1 is improved.

In some other embodiments, as shown in FIG. 5, on the basis of the above-mentioned embodiment, the lithium-supplementing composite diaphragm further includes a first protective layer 105, a second protective layer 102 and a third protective layer 106, that is, the lithium-supplementing composite diaphragm includes a third protective layer 106, a diaphragm layer 101, a second protective layer 102, a lithium metal layer 103, an electronic conductive layer 104 and a first protective layer 105 in sequence. By arranging three protective layers, the risk of exposure of the lithium metal layer is further reduced to avoid partial or full exposure of the lithium metal layer 103 to air, water-containing air, and/or water.

An embodiment of the present application further provides a lithium battery, as shown in FIG. 6, which includes a positive electrode layer 4, a negative electrode layer 3, an electrolyte and a lithium-supplementing composite diaphragm 1 as described in the embodiment shown in FIG. 3 above. Among them, the positive electrode layer 4 includes a positive electrode current collector layer 401 and a positive electrode active material layer 402, and the negative electrode layer 3 includes a negative electrode current collector layer 301 and a negative electrode active material layer 302. The material of the positive electrode active material layer 402 is a ternary material (nickel (Ni), cobalt (Co), manganese (Mn), referred to as NCM), and can also be one or more of lithium cobalt oxide (chemical formula: LiCoO₂, referred to as LCO), lithium iron phosphate (chemical formula: LiFePO₄, referred to as LFP), lithium manganese oxide (chemical formula: LiMn₂O₄, referred to as LMO), lithium nickel manganese oxide (chemical formula can be expressed as LiNi_{0.5}Mn_{1.5}O₄, referred to as LMNO), ternary material (nickel (Ni), cobalt (Co), aluminum (Al), referred to as NCA), or other positive electrode materials. The material of the negative electrode active material layer 302 is a graphite material, and can also be one or more of silicon material, silicon-carbon material, silicon oxide material, soft carbon material, hard carbon material, mesocarbon microbead material, or other negative electrode materials.

An embodiment of the present application further provides a lithium battery, as shown in FIG. 7, which includes a positive electrode layer 4, a negative electrode layer 3, an electrolyte and a lithium-supplementing composite diaphragm 1 as described in the embodiment shown in FIG. 4 above. Among them, the positive electrode layer 4 includes a positive electrode current collector layer 401 and a positive electrode active material layer 402, and the negative electrode layer 3 includes a negative electrode current collector layer 301 and a negative electrode active material layer 302. The material of the positive electrode active material layer 402 is a ternary (NCM) material, and can also be one or more of lithium cobalt oxide (LCO), lithium iron phosphate (LFP), lithium manganese oxide (LMO), lithium nickel manganese oxide (LMNO), ternary (NCA) materials, or other positive electrode materials. The material of the negative electrode active material layer 302 is a graphite material, and can also be one or more of silicon material, silicon-carbon material, silicon oxide material, soft carbon material, hard carbon material, mesocarbon microbead material, or other negative electrode materials.

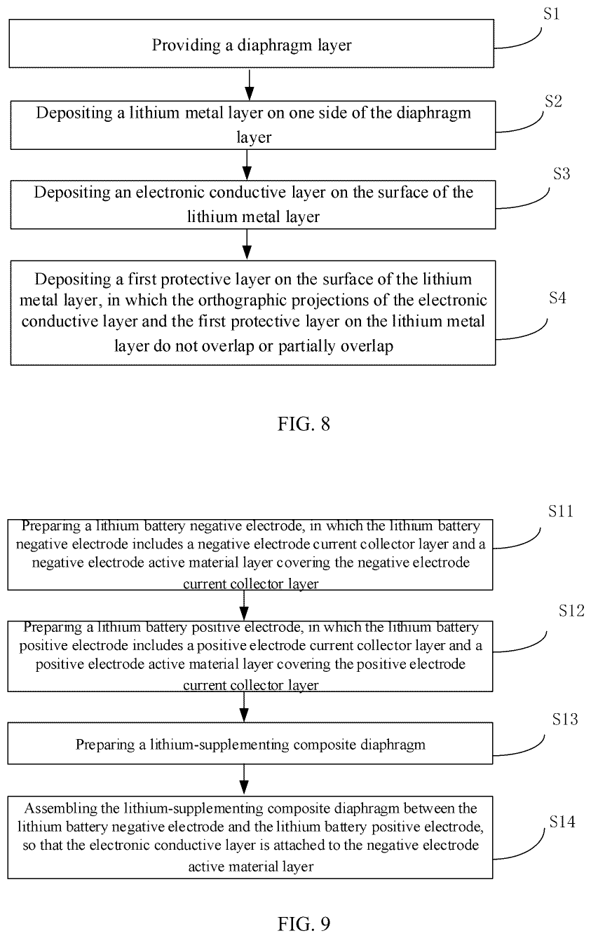

An embodiment of the present application provides a preparation method of a lithium-supplementing composite diaphragm, as shown in FIG. 8, including the following steps:
S1: providing a diaphragm layer;
S2: forming a lithium metal layer on one side of the diaphragm layer;
S3: forming an electronic conductive layer on the surface of the lithium metal layer; and
S4: forming a first protective layer on the surface of the lithium metal layer, in which the orthographic projections of the electronic conductive layer and the first protective layer on the lithium metal layer do not overlap or partially overlap.

In some embodiments, in S2, forming a lithium metal layer on one side of the diaphragm layer includes: forming a second protective layer on one side of the diaphragm layer; and forming a lithium metal layer on the surface of the second protective layer.

In some embodiments, in S2, forming a lithium metal layer on one side of the diaphragm layer includes: forming a second protective layer on one side of the diaphragm layer; and forming a lithium metal layer on the side of the diaphragm layer opposite to the second protective layer.

In some embodiments, the method for forming the first protective layer and/or the second protective layer includes at least one of the following:
blade coating, roller coating, spray coating, chemical vapor deposition, plasma vapor deposition, atomic layer deposition, pulsed laser deposition, vacuum evaporation, ion plating, radio frequency sputtering, magnetron sputtering, or reactive sputtering.

In some embodiments, the method for forming the electronic conductive layer includes at least one of the following: blade coating, roller coating, spray coating, chemical vapor deposition, plasma vapor deposition, atomic layer deposition, pulsed laser deposition, vacuum evaporation, ion plating, radio frequency sputtering, magnetron sputtering, or reactive sputtering.

In some embodiments, the method for forming the lithium metal layer includes at least one of the following: vacuum evaporation, ion plating, radio frequency sputtering, magnetron sputtering, or reactive sputtering.

An embodiment of the present application provides a preparation method of a lithium battery, as shown in FIG. 9, including the following steps:
S11: preparing a lithium battery negative electrode, in which the lithium battery negative electrode includes a negative electrode current collector layer and a negative electrode active material layer covering the negative electrode current collector layer;
S12: preparing a lithium battery positive electrode, in which the lithium battery positive electrode includes a positive electrode current collector layer and a positive electrode active material layer covering the positive electrode current collector layer;
S13: preparing a lithium-supplementing composite diaphragm, in which the preparation method of the lithium-supplementing composite diaphragm adopts any one of the methods described above; and
S14: assembling the lithium-supplementing composite diaphragm between the lithium battery negative electrode and the lithium battery positive electrode, so that the electronic conductive layer is attached to the negative electrode active material layer.

### Comparative Example 1

This Comparative Example provides a ceramic-coated diaphragm and a preparation method of lithium battery, including the following steps:
(1) making a lithium-ion battery positive electrode, in which the lithium-ion battery positive electrode includes a positive electrode current collector and an active material layer covering the surface of the positive electrode current collector;
(2) making a lithium-ion battery negative electrode, in which the lithium-ion battery negative electrode includes a negative electrode current collector and an active material layer covering the surface of the negative electrode current collector; and
(3) making a lithium battery: assembling the positive and negative electrodes obtained in steps (1) and (2), and an aluminum oxide ceramic-coated diaphragm into a battery for testing.

### Comparative Example 2

This Comparative Example provides a preparation method of a lithium-supplementing negative electrode sheet and a lithium battery, including the following steps:
(1) making a lithium-ion battery negative electrode, in which the lithium-ion battery negative electrode includes a negative electrode current collector and an active material layer covering the surface of the negative electrode current collector;
(2) making a lithium-supplementing negative electrode: depositing a lithium layer (lithium metal) on the surface of the battery negative electrode active material on the battery negative electrode obtained in step (1) by using magnetron sputtering technology, with a deposited lithium metal thickness of 1,000 nm;
(3) making a protective layer on the surface of the lithium metal layer of the lithium-supplementing negative electrode obtained in step (2), of which the material is Li₂CO₃, with a thickness of 30 nm;
(4) making a lithium-ion battery positive electrode, in which the lithium-ion battery positive electrode includes a positive electrode current collector and an active material layer covering the surface of the positive electrode current collector; and
(5) assembling the lithium-supplementing negative electrode sheet, positive electrode sheet obtained in steps (3) and (4), and an aluminum ceramic-coated diaphragm into a battery for testing.

### Comparative Example 3

This embodiment provides a preparation method of a lithium-supplementing composite diaphragm and a lithium battery, including the following steps:
(1) making a lithium-supplementing composite diaphragm: depositing a lithium metal layer on the surface of an aluminum ceramic-coated diaphragm using vacuum evaporation technology, with a deposited lithium metal layer thickness of 1000 nm;
(2) making a first protective layer on the surface of the lithium metal layer of the lithium-supplementing composite diaphragm obtained in step (1), of which the material is Li₂CO₃, with a thickness of 30 nm;
(3) making a lithium-ion battery positive electrode layer, in which the lithium-ion battery positive electrode layer includes a positive electrode current collector layer and a positive electrode active material layer covering the surface of the positive electrode current collector layer;
(4) making a lithium-ion battery negative electrode layer, in which the lithium-ion battery negative electrode layer includes a negative electrode current collector layer and a negative electrode active material layer covering the surface of the negative electrode current collector layer; and
(5) assembling the lithium-supplementing composite diaphragm, positive electrode layer, and negative electrode layer obtained in steps (2), (3), and (4) into a battery for testing.

### Comparative Example 4

This embodiment provides a preparation method of a lithium-supplementing composite diaphragm and a lithium battery, including the following steps:
(1) making a lithium-supplementing composite diaphragm: depositing a second protective layer on the surface of an aluminum ceramic-coated diaphragm using magnetron sputtering technology, of which the material is LiPON, with a of thickness 100 nm;
(2) depositing a lithium metal layer on the surface of the second protective layer of the lithium-supplementing composite diaphragm obtained in step (1) by using vacuum evaporation technology on the surface of the aluminum oxide ceramic-coated diaphragm, with a deposited lithium metal layer thickness of 1,000 nm;
(3) making a first protective layer on the surface of the lithium metal layer of the lithium-supplementing composite diaphragm obtained in step (2), of which the material is Li₂CO₃, with a thickness of 30 nm;
(4) making a lithium-ion battery positive electrode layer, in which the lithium-ion battery positive electrode layer includes a positive electrode current collector layer and a positive electrode active material layer covering the surface of the positive electrode current collector layer;
(5) making a lithium-ion battery negative electrode layer, in which the lithium-ion battery negative electrode layer includes a negative electrode current collector layer and a negative electrode active material layer covering the surface of the negative electrode current collector layer; and
(6) assembling the lithium-supplementing composite diaphragm, positive electrode layer, and negative electrode layer obtained in steps (3), (4), and (5) into a battery for testing.

### Embodiment 1

This embodiment provides a preparation method of a lithium-supplementing composite diaphragm and a lithium battery, including the following steps:
(1) making a lithium-supplementing composite diaphragm: depositing a lithium metal layer on the surface of an aluminum ceramic-coated diaphragm using vacuum evaporation technology, with a deposited lithium metal layer thickness of 1000 nm;
(2) depositing an electronic conductive layer on the surface of the lithium metal layer of the lithium-supplementing composite diaphragm obtained in step (1) by using magnetron sputtering technology, with the material of silver, where the coverage rate of the electronic conductive layer on the lithium metal layer is 30%, and the average area of a single conductive unit among a plurality of conductive units in the electronic conductive layer is 2,500 nm²;
(3) making a first protective layer on the surface of the lithium metal layer of the lithium-supplementing composite diaphragm obtained in step (2), of which the material is Li₂CO₃, with a thickness of 30 nm;
(4) making a lithium-ion battery positive electrode layer, in which the lithium-ion battery positive electrode layer includes a positive electrode current collector layer and a positive electrode active material layer covering the surface of the positive electrode current collector layer;
(5) making a lithium-ion battery negative electrode layer, in which the lithium-ion battery negative electrode layer includes a negative electrode current collector layer and a negative electrode active material layer covering the surface of the negative electrode current collector layer; and
(6) assembling the lithium-supplementing composite diaphragm, positive electrode layer, and negative electrode layer obtained in steps (3), (4), and (5) into a battery for testing.

### Embodiment 2

This embodiment provides a preparation method of a lithium-supplementing composite diaphragm and a lithium battery, including the following steps:
(1) making a lithium-supplementing composite diaphragm by depositing a second protective layer on the surface of an aluminum ceramic-coated diaphragm using magnetron sputtering technology, of which the material is LiPON, with a thickness of 100 nm;
(2) depositing a lithium metal layer on the surface of the second protective layer of the lithium-supplementing composite diaphragm obtained in step (1) by using vacuum evaporation technology on the surface of the aluminum oxide ceramic-coated diaphragm, with a deposited lithium metal layer thickness of 1,000 nm;
(3) depositing an electronic conductive layer on the surface of the lithium metal layer of the lithium-supplementing composite diaphragm obtained in step (2) by using magnetron sputtering technology, with the material of silver, where the coverage rate of the electronic conductive layer on the lithium metal layer is 30%, and the average area of a single conductive unit among a plurality of conductive units in the electronic conductive layer is 2,500 nm²;
(4) making a first protective layer on the surface of the lithium metal layer of the lithium-supplementing composite diaphragm obtained in step (3), of which the material is Li₂CO₃, with a thickness of 30 nm;
(5) making a lithium-ion battery positive electrode layer, in which the lithium-ion battery positive electrode layer includes a positive electrode current collector layer and a positive electrode active material layer covering the surface of the positive electrode current collector layer;
(6) making a lithium-ion battery negative electrode layer, in which the lithium-ion battery negative electrode layer includes a negative electrode current collector layer and a negative electrode active material layer covering the surface of the negative electrode current collector layer; and
(7) assembling the lithium-supplementing composite diaphragm, positive electrode layer, and negative electrode layer obtained in steps (3), (4), and (5) into a battery for testing.

### Embodiment 3

This embodiment provides a preparation method of a lithium-supplementing composite diaphragm and a lithium battery, including the following steps:
(1) storing the lithium-supplementing diaphragm obtained in step (3) of Embodiment 1 in a dry air environment for 30 days;
(2) making a positive electrode layer of a lithium-ion battery, in which the positive electrode layer of the lithium-ion battery includes a positive electrode current collector layer and a positive electrode active material layer covering the surface of the positive electrode current collector layer;
(3) making a lithium-ion battery negative electrode layer, in which the lithium-ion battery negative electrode layer includes a negative electrode current collector layer and a negative electrode active material layer covering the surface of the negative electrode current collector layer; and
(4) assembling the lithium-supplementing composite diaphragm, positive electrode layer, and negative electrode layer obtained in steps (1), (2), and (3) into a battery for testing.

### Embodiment 4

This embodiment provides a preparation method of a lithium-supplementing composite diaphragm and a lithium battery, including the following steps:
(1) storing the lithium-supplementing diaphragm obtained in step (4) of Embodiment 2 in a dry air environment for 30 days;
(2) making a positive electrode layer of a lithium-ion battery, in which the positive electrode layer of the lithium-ion battery includes a positive electrode current collector layer and a positive electrode active material layer covering the surface of the positive electrode current collector layer;
(3) making a lithium-ion battery negative electrode layer, in which the lithium-ion battery negative electrode layer includes a negative electrode current collector layer and a negative electrode active material layer covering the surface of the negative electrode current collector layer; and
(4) assembling the lithium-supplementing composite diaphragm, positive electrode layer, and negative electrode layer obtained in steps (1), (2), and (3) into a battery for testing.

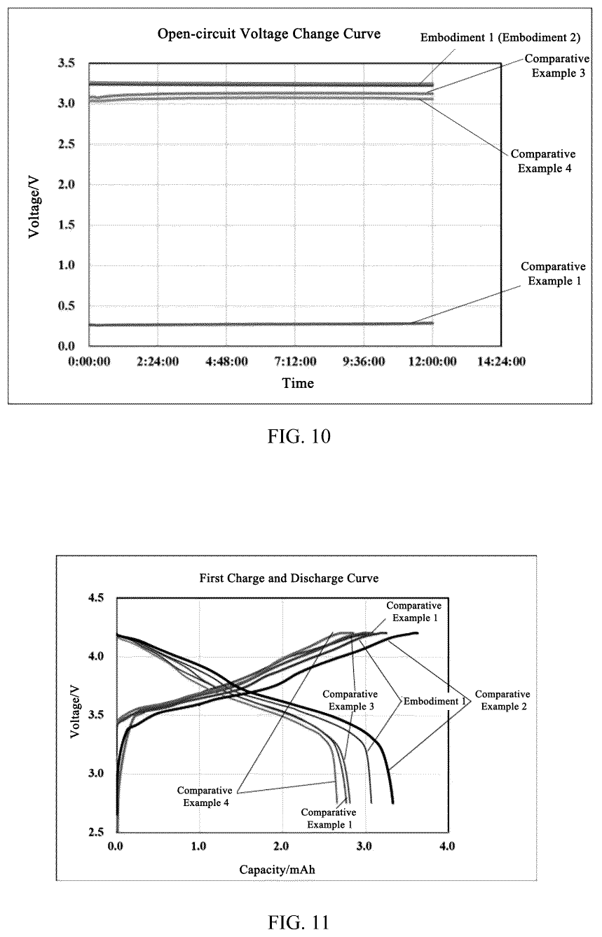

The test data of the lithium batteries obtained in Comparative Example 1, Comparative Example 2, Comparative Example 3, Comparative Example 4, Embodiment 1, Embodiment 2, Embodiment 3, and Embodiment 4 are compared, and the specific data are summarized in Table 1. The open-circuit voltage change curves are shown in FIG. 10, and the first charge and discharge curves are shown in FIG. 11.

TABLE 1
Comparison of battery test data between the
Comparative Examples and the embodiments

| | Initial | Time for | | Utilization |
|---|---|---|---|---|
| | open-circuit | open-circuit | Initial | rate of |
| Battery | voltage | voltage to | coulombic | lithium |
| sample | (V) | stabilize (h) | efficiency | metal layer |
| Comparative | 0.26 | / | 89.2% | / |
| Example 1 | | | | |
| Comparative | 2.89 | / | 91.9% | 26.1% |
| Example 2 | | | | |
| Comparative | 3.11 | 10 | 93.7% | 44.1% |
| Example 3 | | | | |
| Comparative | 3.08 | 10 | 93.7% | 44.1% |
| Example 4 | | | | |
| Embodiment 1 | 3.26 | 3 | 94.3% | 49.3% |
| Embodiment 2 | 3.24 | 3 | 94.3% | 49.3% |
| Embodiment 3 | 0.36 | / | 89.5% | 0% |
| Embodiment 4 | 3.23 | / | 92.2% | 29.5% |

By comparing the battery test data in Table 1 and the open-circuit voltage change curves in FIG. 10, it can be seen that the initial open-circuit voltage of Comparative Example 1 is basically stable at about 0.26 V, the initial open-circuit voltage of Comparative Example 2 is basically stable at about 2.89 V, the initial open-circuit voltage of Comparative Example 3 is basically stable at about 3.11 V, the initial open-circuit voltage of Comparative Example 4 is basically stable at about 3.08 V, the initial open-circuit voltage of Embodiment 1 is 3.26 V, and the initial open-circuit voltage of Embodiment 2 is 3.24 V. It can be seen that the initial open-circuit voltages of Embodiments 1-2 using the lithium-supplementing diaphragm are significantly improved, and even have a certain degree of improvement compared with Comparative Example 3 and Comparative Example 4. After using the lithium-supplementing diaphragms of Comparative Examples 3-4 (without electron conductive layer), the initial open-circuit voltage has a slow rising stage in an initial period, which tends to be stable after about 10 hours. However, after using the lithium-supplementing diaphragms of Embodiments 1-2 (with electron conductive layer), the stable initial open-circuit voltage is reached within 3 hours. Therefore, after the lithium batteries assembled with the lithium-supplementing composite diaphragms prepared in Embodiments 1-2 of the present application, pre-lithiation behavior has begun before the charge-discharge test, and when there is an electron conductive layer, the pre-lithiation speed is significantly improved.

By comparing the battery test data in Table 1 and the first charge and discharge curves in FIG. 11, it can be seen that the initial Coulombic efficiency of Comparative Example 1 is 89.2%, the initial Coulombic efficiency of Comparative Example 2 is 91.9%, the initial Coulombic efficiency of Comparative Example 3 is 93.7%, the initial Coulombic efficiency of Comparative Example 4 is 93.7%, the initial Coulombic efficiency of Embodiment 1 is 94.3%, and the initial Coulombic efficiency of Embodiment 2 is 94.3%. It can be seen that the lithium-supplementing composite diaphragms manufactured in Embodiments 1-2 of the present application can effectively improve the initial Coulombic efficiency of lithium batteries, and when there is an electron conductive layer, the initial Coulombic efficiency is the highest, and the utilization rate of the lithium metal layer can be significantly improved.

By comparing the battery test data in Table 1 and the first charge and discharge curves in FIG. 11, it can be seen that the initial Coulombic efficiency of Comparative Example 2 is 91.9%, and the utilization rate of the lithium metal layer is 26.1%; the initial Coulombic efficiency of Comparative Example 3 is 93.7%, and the utilization rate of the lithium metal layer is 44.1%; the initial Coulombic efficiency of Comparative Example 4 is 93.7%, and the utilization rate of the lithium metal layer is 44.1%; the initial Coulombic efficiency of Embodiment 1 is 94.3%, and the utilization rate of the lithium metal layer is 49.3%; the initial Coulombic efficiency of Embodiment 2 is 94.3%, and the utilization rate of the lithium metal layer is 49.3%. It can be seen that the lithium-supplementing composite diaphragms manufactured in Embodiments 1-2 of the present application are superior to the lithium-supplementing negative electrode sheets manufactured in Comparative Examples 2-4, especially superior to the lithium-supplementing negative electrode sheet manufactured in Comparative Example 2, in terms of improving the initial efficiency of lithium batteries and the utilization rate of the lithium metal layer.

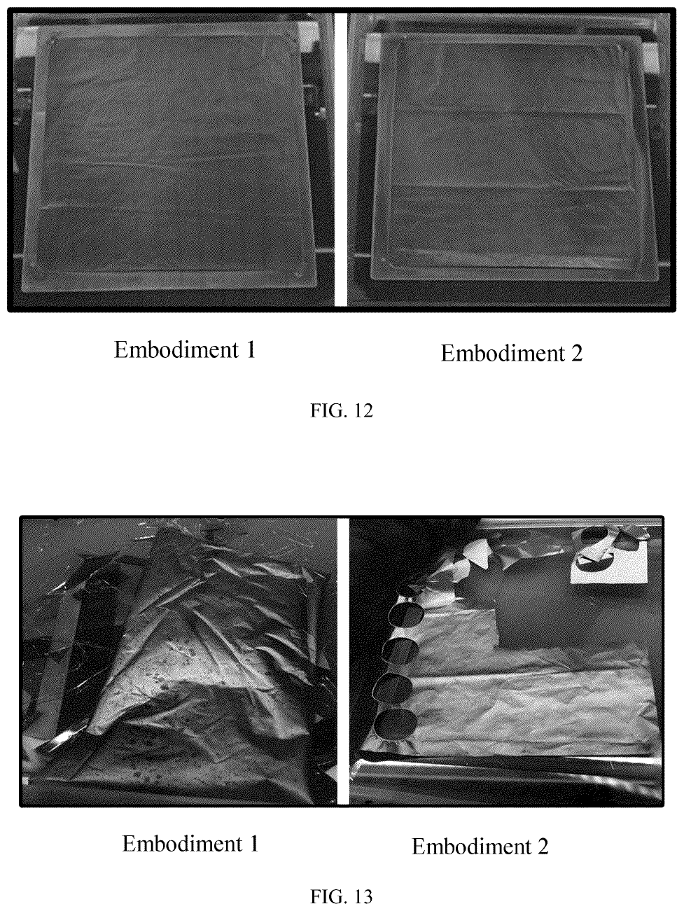

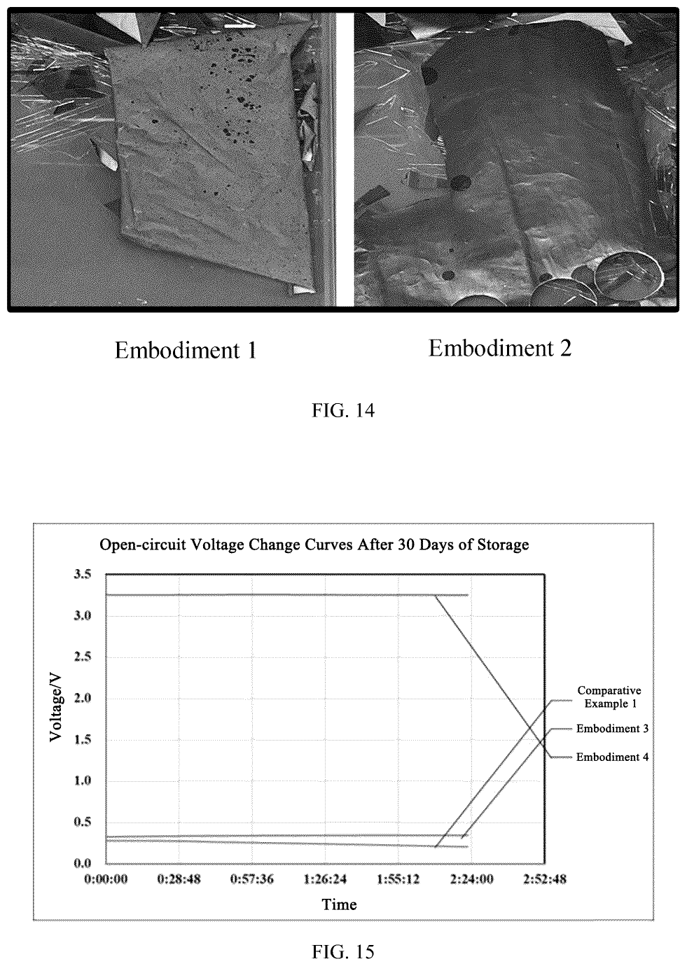

The composite diaphragm obtained in Embodiment 1 and the composite diaphragm obtained in Embodiment 2 are placed under the same conditions. The initial state comparison of the diaphragms is shown in FIG. 12. After being placed for 15 days, the diaphragm state comparison is shown in FIG. 13. After being placed for 30 days, the diaphragm state comparison is shown in FIG. 14.

By comparing FIG. 12 and FIG. 13, it can be seen that the state changes of the lithium-supplementing composite diaphragm obtained in Embodiment 1 and the lithium-supplementing composite diaphragm obtained in Embodiment 2 are different. After being placed for 15 days, the lithium metal layer of the lithium-supplementing composite diaphragm of Embodiment 1 has undergone many side reactions, and a large number of dark spots appear on the surface of the diaphragm, as indicated by the arrows in FIG. 13, while the lithium metal layer of the lithium-supplementing composite diaphragm of Embodiment 2 has no dark spots, indicating that no or few side reactions occur;

By comparing FIG. 12 and FIG. 14, it can be seen that the state changes of the lithium-supplementing composite diaphragm obtained in Embodiment 1 and the lithium-supplementing composite diaphragm obtained in Embodiment 2 are different. After being placed for 30 days, the lithium metal layer of the lithium-supplementing composite diaphragm of Embodiment 1 has been completely consumed by side reactions, while the lithium metal layer of the lithium-supplementing composite diaphragm of Embodiment 2 has only undergone a small amount of side reactions, and only a small number of dark spots appear on the surface of the diaphragm.

By comparing the battery test data in Table 1 and the open-circuit voltage change curves after 30 days of storage in FIG. 15, it can be seen that the initial open-circuit voltage of Comparative Example 1 is basically stable at about 0.26 V, the initial open-circuit voltage of Embodiment 3 is 0.36 V, which is not much different from the initial open-circuit voltage of Comparative Example 1; while the initial open-circuit voltage of Embodiment 4 is 3.23 V, which is significantly higher than the initial open-circuit voltages of Comparative Example 1 and Embodiment 3. This indicates that after the lithium-supplementing composite diaphragm of Embodiment 4 is stored for 30 days and assembled into a lithium battery, pre-lithiation behavior still exists before the charge-discharge test.

By comparing the battery data in Table 1, it can be seen that the initial Coulombic efficiency of Embodiment 3 is 89.5%, and the utilization rate of the lithium metal layer is 0%; the initial Coulombic efficiency of Embodiment 4 is 92.2%, and the utilization rate of the lithium metal layer is 29.5%. It can be seen that the pre-lithiation composite diaphragm with the second protective layer can still perform pre-lithiation after being stored for 30 days.

All these indicate that in Embodiment 2 and Embodiment 4 with the second protective layer, the second protective layer can play a significant protective role on the lithium metal layer, improve the storage life and service life of the lithium-supplementing composite diaphragm, and reduce the requirements of the lithium-supplementing composite diaphragm on storage conditions and use conditions.

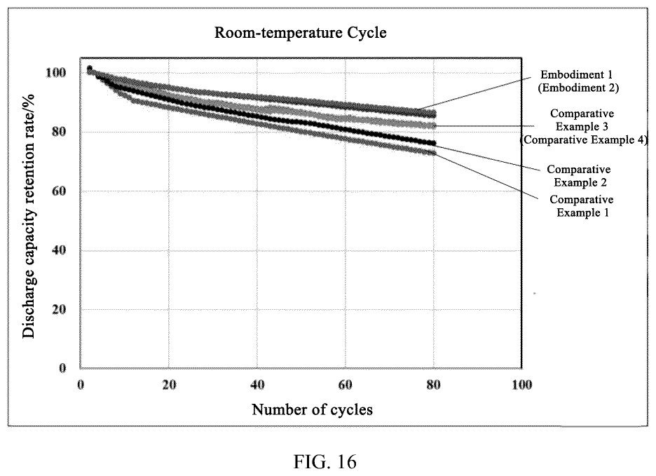

By comparing the room-temperature cycle curves in FIG. 16, it can be seen that after 80 cycles, the discharge capacity retention rates of Embodiments 1-2 of the present application are all higher than the discharge capacity retention rates of Comparative Examples 1-4. It can be seen that the lithium-supplementing composite diaphragms prepared in Embodiments 1-2 of the present application can effectively improve the cycle performance of lithium batteries.

By comparing the room-temperature cycle curves in FIG. 16, it can be seen that the curves of Embodiments 1-2 of the present application are significantly higher than those of Comparative Examples 1-4, indicating that the cycle performance of Embodiments 1-2 of the present application is significantly better than that of Comparative Example 2. It can be seen that the lithium-supplementing composite diaphragms manufactured in Embodiments 1-2 of the present application are superior to the lithium-supplementing negative electrode sheets of Comparative Examples 1-4 in terms of improving the cycle performance of batteries.

By comparing the room-temperature cycle curves of Comparative Example 3 and Comparative Example 4, and the room-temperature cycle curves of Embodiment 1 and Embodiment 2 in FIG. 16, it can be seen that the curves of Comparative Example 3 and Comparative Example 4 are basically the same, and the curves of Embodiment 1 and Embodiment 2 are also basically the same, with no significant difference. It can be seen that the second protective layer has no obvious side effects on the cycle performance of the battery.

By comparing the room-temperature cycle curves of Comparative Example 3 and Embodiment 1, and the room-temperature cycle curves of Comparative Example 4 and Embodiment 2 in FIG. 16, it can be seen that the curve of Embodiment 1 is significantly higher than that of Comparative Example 3, and the curve of Embodiment 2 is also significantly higher than that of Comparative Example 4, indicating that the cycle performance of Embodiment 1 is significantly better than that of Comparative Example 3, and the cycle performance of Embodiment 2 is significantly higher than that of Comparative Example 4. It can be seen that when the lithium-supplementing composite diaphragm manufactured in the present application has an electron conductive layer, the cycle performance of the battery can be further improved.

The lithium-supplementing composite diaphragm of the present application can be directly applied to negative electrode lithium supplementation, thereby improving the initial coulombic efficiency and cycle life of lithium battery. The lithium-supplementing composite diaphragm of the present application can control the degree of lithium supplementation (pre-lithiation) by regulating the thickness of the lithium layer, and improves the utilization rate of lithium in the pre-lithiation process. The composite diaphragm of the present application reduces the generation of dead lithium and further improves the utilization rate of lithium by providing an electronic conductive channel between the lithium layer and the negative electrode active material. The lithium-supplementing composite diaphragm of the present application does not change the normal production process of lithium batteries and thus does not reduce the production efficiency of lithium batteries. The lithium-supplementing composite diaphragm of the present application has a protective layer on both sides of the lithium layer, which isolates the lithium layer from contact with the external environment, so that the lithium layer does not react with air and water in the environment, making the lithium-supplementing composite diaphragm have relatively low requirements for the storage environment. In addition, the lithium-supplementing composite diaphragm of the present application provides electronic conductive paths and ionic conductive paths between the lithium layer and the negative electrode active material. After assembling the battery, a solid electrolyte film (SEI) can be formed in situ, further reducing the loss of active lithium and improving the coulombic efficiency and cycle life of the lithium battery.

Finally, it should be noted that the embodiments in this specification are described in a progressive manner, with each embodiment focusing on the differences from other embodiments. The same and similar parts between the embodiments can be referred to each other.

It should be noted that the above embodiments are only used to illustrate the technical solutions of the present application, and are not intended to limit them. Although the present application has been described in detail with reference to the aforementioned embodiments, those of ordinary skill in the art will appreciate that modifications can still be made to the technical solutions described in the aforementioned embodiments, or equivalents may be substituted for certain technical features. Such modifications or substitutions do not make the essence of the corresponding technical solutions depart from the spirit and scope of the technical solutions of the embodiments of the present application.

What is claimed is:

1. A lithium-supplementing composite diaphragm for lithium batteries, the lithium battery comprises a negative electrode layer and a positive electrode layer, the lithium-supplementing composite diaphragm is arranged between the negative electrode layer and the positive electrode layer, wherein the lithium-supplementing composite diaphragm comprises:
a diaphragm layer, configured to isolate the negative electrode layer and the positive electrode layer;
a lithium metal layer, arranged on the side of the diaphragm layer close to the negative electrode layer, and configured to supplement lithium to the negative electrode layer;
a first protective layer, arranged on the side of the lithium metal layer close to the negative electrode layer; and
an electronic conductive layer, arranged on the side of the lithium metal layer close to the negative electrode layer, and configured to provide an electronic conductive channel between the lithium metal layer and the negative electrode layer,
wherein the orthographic projections of the electron conductive layer and the first protective layer on the lithium metal layer partially overlap, so that there is no gap between the electronic conductive layer and the first protective layer, thereby ensuring that the electron conductive layer and the first protective layer can 100% completely cover the lithium metal layer;
the material of the first protective layer comprises at least one of the following:
Al₂O₃, MgO, ZnO₂, TiO₂, ZrO₂, LaO₂, CeO₂, Y₂O₃, SiₓO, SiC, SiNₓ, SiCNₓ, AlN, Mg(OH)₂, BaSO₄, boehmite or perovskite; or
Li₂CO₃, Li₃N, LiF, Li₃PO₄, Li₄SiO₄, Li₄Ti₅O₁₂, LiPON, LiSiON, LLZO, LLZTO, LATP, Li₃Fe₂(PO₄)₃, Li₃V₂(PO₄)₃, Li₃In₂(PO₄)₃, Li₃Sc₂(PO₄)₃, and Li₃Cr₂(PO₄)₃; and
the method for forming the first protective layer comprises at least one of the following: blade coating, roller coating, spray coating, chemical vapor deposition, plasma vapor deposition, atomic layer deposition, pulsed laser deposition, vacuum evaporation, ion plating, radio frequency sputtering, magnetron sputtering, or reactive sputtering.

2. The lithium-supplementing composite diaphragm according to claim 1, wherein the lithium-supplementing composite diaphragm further comprises:
a second protective layer, arranged on the side of the lithium metal layer away from the negative electrode layer.

3. The lithium-supplementing composite diaphragm according to claim 1, wherein the lithium-supplementing composite diaphragm further comprises:
a second protective layer, arranged on the side of the diaphragm layer away from the lithium metal layer.

4. The lithium-supplementing composite diaphragm according to claim 1, wherein the shape of the orthographic projection of the electronic conductive layer on the lithium metal layer is island-like, in which the island-like shape comprises a plurality of non-continuous islands and/or at least one mesh formed by connecting a plurality of islands.

5. The lithium-supplementing composite diaphragm according to claim 1, wherein the thickness of the electronic conductive layer is greater than the thickness of the first protective layer.

6. The lithium-supplementing composite diaphragm according to claim 1, wherein the thickness of the electronic conductive layer is 10 nm-1,000 nm.

7. The lithium-supplementing composite diaphragm according to claim 1, wherein the coverage rate of the electronic conductive layer on the lithium metal layer is 10%-90%.

8. The lithium-supplementing composite diaphragm according to claim 1, wherein the area of a single electronic conductive layer is 100 nm²-1,000,000 nm².

9. The lithium-supplementing composite diaphragm according to claim 2, wherein the thickness of the first protective layer and/or the second protective layer is 10 nm-1,000 nm.

10. The lithium-supplementing composite diaphragm according to claim 1, wherein the thickness of the lithium metal layer is 0.1 μm-10 μm, and the lithium metal layer is a dense or porous loose structure.

11. The lithium-supplementing composite diaphragm according to claim 1, wherein the material of the electronic conductive layer comprises at least one of the following: metal, metal oxide, metal nitride, metal sulfide, or carbon material.

12. The lithium-supplementing composite diaphragm according to claim 2, wherein the material of the second protective layer comprises at least one of the following:
Al₂O₃, MgO, ZnO₂, TiO₂, ZrO₂, LaO₂, CeO₂, Y₂O₃, SiₓO, SiC, SiNₓ, SiCNₓ, AlN, Mg(OH)₂, BaSO₄, boehmite, or perovskite; or
Li₂CO₃, Li₃N, LiF, Li₃PO₄, Li₄SiO₄, Li₄Ti₅O₁₂, LiPON, LiSiON, LLZO, LLZTO, LATP, Li₃Fe₂(PO₄)₃, Li₃V₂(PO₄)₃, Li₃In₂(PO₄)₃, Li₃Sc₂(PO₄)₃, and Li₃Cr₂(PO₄)₃.

13. The lithium-supplementing composite diaphragm according to claim 1, wherein the diaphragm layer is one of the following: a base film, a base film/ceramic composite diaphragm, a base film/adhesive composite diaphragm, and a base film/ceramic/adhesive composite diaphragm.

14. The lithium-supplementing composite diaphragm according to claim 13, wherein
the base film comprises at least one of the following: a polyethylene base film, a polyethylene nonwoven base film, a polypropylene base film, a polypropylene nonwoven base film, a polypropylene/polyethylene/polypropylene composite base film, a polyimide base film, a polyimide nonwoven base film, a polytetrafluoroethylene base film, a polytetrafluoroethylene nonwoven base film, a polyvinyl chloride base film, or a polyvinyl chloride nonwoven base film; and/or,
the ceramic comprises at least one of the following: aluminum oxide, zirconium oxide, boehmite, magnesium hydroxide, barium sulfate, silicon oxide, aluminum nitride, magnesium oxide, titanium dioxide, yttrium oxide, or cerium oxide; and/or,
the adhesive comprises at least one of the following: polytetrafluoroethylene, polyvinylidene fluoride, acrylic acid, polyethylene oxide, sodium carboxymethyl cellulose, styrene-butadiene rubber, hydroxypropyl methylcellulose, carboxylated styrene-butadiene latex, or polyvinyl alcohol.

15. The lithium-supplementing composite diaphragm according to claim 1, wherein
the lithium metal layer comprises at least one of the following: lithium metal, lithium silicon alloy, lithium tin alloy, lithium magnesium alloy, lithium copper alloy, lithium silver alloy, lithium beryllium alloy, lithium zinc alloy, lithium cadmium alloy, lithium aluminum alloy, lithium gold alloy, and lithium boron alloy.

16. A lithium battery, comprising the lithium-supplementing composite diaphragm according to claim 1, wherein the negative electrode layer comprises a negative electrode current collector layer and a negative electrode active material layer covering the negative electrode current collector layer; the positive electrode layer comprises a positive electrode current collector layer and a positive electrode active material layer covering the positive electrode current collector layer.

17. A preparation method of a lithium-supplementing composite diaphragm according to claim 1, comprising the following steps:
providing a diaphragm layer;
forming a lithium metal layer on one side of the diaphragm layer;
forming an electronic conductive layer on the surface of the lithium metal layer; and
forming a first protective layer on the surface of the lithium metal layer, in which the orthographic projections of the electronic conductive layer and the first protective layer on the lithium metal layer partially overlap.

18. The method according to claim 17, wherein the forming of a lithium metal layer on one side of the diaphragm layer comprises:
forming a second protective layer on one side of the diaphragm layer; and
forming a lithium metal layer on the surface of the second protective layer.

19. The method according to claim 17, wherein the forming of a lithium metal layer on one side of the diaphragm layer comprises:
forming a second protective layer on one side of the diaphragm layer; and
forming a lithium metal layer on the side of the diaphragm layer opposite to the second protective layer.

20. A preparation method of a lithium battery, wherein it comprises the following steps:
preparing a lithium battery negative electrode, in which the lithium battery negative electrode comprises a negative electrode current collector layer and a negative electrode active material layer covering the negative electrode current collector layer;
preparing a lithium battery positive electrode, in which the lithium battery positive electrode comprises a positive electrode current collector layer and a positive electrode active material layer covering the positive electrode current collector layer;
preparing a lithium-supplementing composite diaphragm, wherein the preparation method of the lithium-supplementing composite diaphragm adopts the method described in claim 17; and
assembling the lithium-supplementing composite diaphragm between the lithium battery negative electrode and the lithium battery positive electrode, so that the electronic conductive layer is attached to the negative electrode active material layer.
